(19) United States
(12) Patent Application Publication
(10) Pub. No.: US 2026/0133286 A1
(43) Pub. Date: May 14, 2026

(54) Optoelectronic sensor for detecting objects in a monitored zone

(71) Applicant: SICK AG, Waldkirch (DE)

(72) Inventors: Wolfram STREPP, Freiburg (DE); Joerg SIGMUND, Kenzingen (DE); Govinda KEMPERMANN, Gutach (DE)

(21) Appl. No.: 19/382,624

(22) Filed: Nov. 7, 2025

(30) Foreign Application Priority Data
Nov. 8, 2024 (DE) 10 2024 132 664.6

(51) Int. Cl. G01S 7/48; G01S 7/4865; G01S 17/86

(52) U.S. Cl. CPC G01S 7/4808; G01S 7/4865; G01S 17/86

(57) ABSTRACT

An optoelectronic sensor, in particular a time-of-flight camera or a LIDAR sensor, detects at least one object in a monitored zone. The optoelectronic sensor includes a light transmitter, a light receiver and an evaluation unit. The light transmitter is configured to transmit transmission light into the monitored zone. The light receiver is configured to receive reception light remitted by the object in the monitored zone. The evaluation unit is configured to obtain distance data about the remitting object in the monitored zone, based on the reception light. The distance data include intensity values and associated distance values, to determine a distance of the object based on the distance data, and to recognize those data portions in the distance data as interference in which an intensity value is smaller than a predetermined first intensity limit value and the associated distance value lies within a tolerance range around the determined distance.

The invention relates to an optoelectronic sensor, in particular a time-of-flight camera or a LIDAR sensor, for detecting at least one object in a monitored zone, wherein the optoelectronic sensor comprises means to recognize data portions in obtained distance data about the monitored zone as interference.

Optoelectronic sensors can be used for industrial safety applications and can allow a safe environmental perception of a monitored zone, and in particular a safe three-dimensional environmental perception of the monitored zone, whereby the safety and efficiency of industrial processes in industrial plants can be increased. Examples of such optoelectronic sensors are ToF (Time-of-Flight) cameras and LIDAR (Light Detection And Ranging) sensors. Optoelectronic sensors can, for example, be attached in a stationary manner in the industrial plant or to robots that can move autonomously in the industrial plant. In the industrial plant, reflectors can be attached that are used by the optoelectronic sensors on the autonomous robots to control, localize and/or navigate the robots.

In typical reception lenses of optoelectronic sensors, multiple reflections from very bright objects in the monitored zone, such as reflectors, high-visibility vests, metallic or reflective objects, often lead to ghost images and/or double images and in particular to so-called ghost objects. The reception light of a strongly remitting (i.e. bright) object can be partly scattered in the lens of the optoelectronic sensor at lens edges and/or other optical elements in the optoelectronic sensor so that a scattered light halo is created around the object. This scattered light can appear as a ghost object, in particular in front of a less strongly remitting (i.e. dark) background. This ghost object typically appears at the same distance as the bright object since it is the same reception light (except for a small additional path length due to the scattering in the lens). Such ghost objects can, in an unwanted manner, trigger a warning field or protected field configured in the optoelectronic sensor, and can thus unnecessarily cause a safety stop of an autonomous robot. This reduces the availability of the robots in their intended use and/or can even render the optoelectronic sensor completely unusable for the use in the industrial plant since they repeatedly trigger a safety stop of the robots at the same positions in the industrial plant (near the reflectors).

Known optoelectronic sensors attempt to overcome or to avoid the formation of ghost images and/or double images by using reception lenses that have fewer internal reflections. However, such reception lenses are complex, expensive, difficult to implement and/or can possibly nevertheless only be of limited help against a so-called “toxic” reflector behavior. Other known optoelectronic sensors reduce the intensity of the transmission light. However, a reduction in the transmission light is usually accompanied by a reduction in the range, a reduction in the field of view, detection losses and/or accuracy losses.

The invention is based on the object of providing an improved optoelectronic sensor, in particular with regard to the avoidance of ghost images and/or double images.

An optoelectronic sensor having the features of claim 1 is provided to satisfy the object.

The optoelectronic sensor according to the invention, in particular a time-of-flight camera or a LiDAR sensor, for detecting at least one object in a monitored zone comprises a light transmitter, a light receiver and an evaluation unit. The light transmitter is configured to transmit transmission light into the monitored zone. The light receiver is configured to receive reception light remitted by the monitored zone, and in particular by the object in the monitored zone The evaluation unit is configured to obtain distance data about the monitored zone, and in particular about the remitting object in the monitored zone (in particular to measure said distance data by means of a time-of-flight method), based on the reception light, wherein the distance data comprise intensity values and associated distance values, to determine a distance of the object based on the distance data, and to recognize those data portions (e.g. pixels) in the distance data as interference in which an intensity value is smaller than a predetermined first intensity limit value and the associated distance value lies within a tolerance range around the determined distance of the object.

In other words, the invention is based on the realization that a ghost object usually appears at approximately the same distance from the optoelectronic sensor as the (real) remitting object. The intensity of the so-called ghost object is in this respect often rather low, and in particular usually lower than the intensity of other detectable objects in the monitored zone (defined by the technical conditions of the optoelectronic sensor). Based on this, those data portions which represent an interference or a ghost object can be recognized and filtered out.

The optoelectronic sensor is preferably a safe sensor, i.e. a safety sensor, and in particular a safety ToF camera or a safety LiDAR sensor. The terms safe or safety can be understood within the meaning of the ISO 13849 standard. The optoelectronic sensor can therefore allow errors to be controlled up to a certain safety level.

The distance of the object can mean a (mean) relative distance from the optoelectronic sensor. The tolerance range can, for example, comprise a range of ±50 cm, preferably ±20 cm, preferably ±12 cm, preferably ±10 cm, and preferably ±5 cm around the determined distance of the object.

According to one embodiment, the tolerance range comprises a range of ±20%, preferably ±15%, preferably ±10%, preferably ±6%, preferably ±5%, and preferably ±1% of the value of the determined distance of the object around the determined distance of the object.

The transmission light is remitted by the object (and also by other objects) in the monitored zone as reception light for the light receiver of the optoelectronic sensor.

According to one embodiment, the object is a reflector (e.g. a retroreflector), wherein the reflector preferably has a remission of greater than 90%, preferably greater than 95%, and preferably greater than 99%. The reflector can be a retroreflector whose remission can also be specified with a value of greater than 100%, in particular significantly greater than 100%. The reflector can be attached in the industrial plant for the purpose of the control, localization and/or navigation of autonomous robots.

According to one embodiment, the evaluation unit is configured to determine a size and/or an intensity of the remitting object based on the distance data, and to determine the distance of the object (only) if and/or to carry out the recognition of those data portions in the distance data which represent an interference (only) if the size of the object is equal to or greater than a predetermined size limit value and/or if the intensity of the object is equal to or greater than a predetermined second intensity limit value. The second intensity limit value can preferably correspond to a percentage of the maximum intensity value that can be measured by the optoelectronic sensor, i.e., for example, to a proportion of 80%, preferably 90%, preferably 95%, preferably 99% and preferably 100% of the maximum measurable intensity value, wherein the maximum measurable intensity value can, for example, have the value of an arbitrary unit (e.g. 20,000 AU or 20,000 digits).

The second intensity limit value preferably corresponds to the saturation value of the optoelectronic sensor. The size of the object can, for example, be measured based on a number of pixels or, converted, based on a (real) spatial extent. The size of the object (e.g. a reflector) can be known. The object can e.g. typically have a width of 50 mm and a height of 100 mm. In addition, the object can, as known, be a very bright, i.e. strongly remitting, object. Based on this, it can then be recognized whether such an object (i.e., for example, a reflector) having the specific properties is located in the monitored zone or not. If so, the interference recognition or the recognition (and filtering) of those data portions which represent an interference, and in particular a ghost object, is carried out. If not, the interference recognition or the recognition (and filtering) of those data portions which represent an interference, and in particular a ghost object, can be omitted. This procedure of the selective recognition (and filtering) can in particular be important for safety applications since it must be avoided as far as possible here that valid data portions (i.e. data portions of genuine, existing objects) are inadvertently filtered out. Furthermore, the efficiency of the optoelectronic sensor can be increased in this way. If a plurality of sufficiently large and sufficiently remitting (bright) objects (e.g. reflectors) are recognized, the process of the interference recognition described herein can be carried out iteratively for each of these objects.

According to one embodiment, the distance data comprise a plurality of pixels that each have an intensity value and an associated distance value.

According to one embodiment, the evaluation unit is configured to recognize those pixels in the distance data as interference whose intensity value is smaller than the first intensity limit value and whose distance value lies within a tolerance range around the determined distance of the object. The data portions that represent an interference can therefore refer to these pixels that are recognized as interference and that can also be called ghost pixels.

According to one embodiment, the evaluation unit is configured to enter each pixel, and in particular each pixel of the object, in the distance data whose intensity value is equal to or greater than the second intensity limit value, and which is in particular overdriven, into a distance histogram, to recognize a peak (i.e. a peak value or an apex) in the distance histogram, to determine the size of the object based on the number of pixels under the peak, and to determine the distance of the object based on the position of the peak in the distance histogram. In this respect, the peak is preferably the largest peak in the distance histogram. The evaluation unit can further be configured to perform a prior image segmentation so that only pixels of certain regions are entered into the distance histogram. The peak can be recognized by means of common algorithms for (global) maxima detection (e.g. by means of the Matlab function “max”).

According to one embodiment, the evaluation unit is configured to compare the distance of the object with a predetermined distance limit value and to carry out the recognition of those data portions (and in particular those pixels) which represent an interference only if the distance is equal to or smaller than the distance limit value. Otherwise, the evaluation unit can cancel the evaluation at this point, can skip the recognition of interference and/or can cause a signal to be output. The distance limit value can be predefined by the technical possibilities of the camera and/or a safety level and can, for example, amount to 1000 cm, preferably 500 cm, preferably 400 cm and preferably 200 cm.

According to one embodiment, the first intensity limit value is defined based on (previously measured) distance data of a test specimen. This can be a test specimen defined in a safety-relevant standard. According to one embodiment, the first intensity limit value has a predetermined value that preferably results from a safety consideration and an energetic design of the optoelectronic sensor. For example, the first intensity limit value can be determined based on the measurement of worst-case data about a worst-case test specimen (e.g. remission of 4%).

According to one embodiment, the first intensity limit value is smaller than the minimum intensity value in the distance data of the object.

According to one embodiment, the first intensity limit value is determined in dependence on the distance of the object. Alternatively or additionally, according to one embodiment, the first intensity limit value is defined based on an intensity of an object to be detected or that can be detected (by the optoelectronic sensor) with the lowest remission. The first intensity limit value can, for example, correspond to a percentage (e.g. 50%) of the intensity of an object to be detected or that can be detected, said object being defined in the detection concept of the optoelectronic sensor with a remission of equal to or less than 5%, and in particular at 4%. In other words, the first intensity limit value can be defined based on the intensity of the darkest object (i.e. an object with the lowest remission) in the monitored zone, which object is still detectable (with a certain safety level) for the optoelectronic sensor.

According to one embodiment, the first intensity limit value is limited (upwards) by a predetermined maximum value. The intensity limit value can therefore be limited by a predetermined maximum value for safety reasons, wherein the maximum value can, for example, have the value of an arbitrary unit, for example, 15 AU or 15 digits.

According to one embodiment, the first intensity limit value is determined as a function of a minimum intensity limit value at a predetermined distance limit value, of the distance limit value, and of the distance of the object. The distance limit value can be 500 cm, preferably 400 cm and preferably 200 cm. The minimum intensity limit value at the distance limit value can be based on a remission limit for a (still) detectable object at the distance limit value and can in particular correspond to a proportion (e.g. 50%) of the remission limit for a (still) detectable object at the distance limit value. Preferably, the minimum intensity limit value at the predetermined distance limit value corresponds to a remission of 2%, which can correspond to a percentage of 50% of the intensity of an object to be detected or that can be detected, said object being defined in the detection concept of the optoelectronic sensor with a remission of 4%. The minimum intensity limit value at the distance limit value can have the value of an arbitrary unit, for example, 5 AU or 5 digits.

According to one embodiment, the first intensity limit value I_{thr,1} is determined using the following equation 1,

$${I}_{t h r , 1} = {I}_{min} \cdot {( \frac{{D}_{t h r}}{{D}_{o b j}} )}^{2} , \qquad [ Equation 1 ]$$

where Iₘᵢₙ is the minimum intensity limit value at the distance limit value Dₜₕᵣ and D_{obj} is the distance of the object.

According to one embodiment, the evaluation unit is further configured to recognize those data portions in the distance data as interference in which the intensity value is smaller than a predetermined third intensity limit value, wherein the third intensity limit value is preferably set to a fixed value. The third intensity limit value can in particular be independent of the distance of the object and can preferably be set to a standard value, e.g. 5 AU or 5 digits.

According to one embodiment, the evaluation unit is configured to recognize those data portions in the distance data as interference in which the intensity value is smaller than a predetermined third intensity limit value and the associated distance value is outside the tolerance range around the determined distance of the object.

According to one embodiment, the data portions (e.g. pixels) in the distance data that are recognized as interference are, in particular for the control of the movement of a robot (which is an autonomous robot), removed (or filtered out) from the distance data, marked as invalid and/or ignored in a further evaluation of the distance data.

According to one embodiment, the evaluation unit is configured to recognize those data portions in the distance data as interference whose intensity value/Bp fulfills the following equation 2,

$${I}_{B P} < {I}_{t h r , 1} , \qquad [ Equation 2 ]$$

and whose associated distance value D_{BP} fulfills the following equation 3,

$${D}_{O b j} - {Δ}_{Tol} \leq {D}_{B P} \leq {D}_{O b j} + {Δ}_{Tol} , \qquad [ Equation 3 ]$$

where ΔTol defines the tolerance range.

In other words, due to the combination of the filtering according to the tolerance range around the determined distance (in other words, according to a distance corridor) and the filtering according to the first intensity limit value, wherein both are preferably determined based on the distance of the detected, remitting object, the ghost pixels generated by the (strongly remitting, bright) object can be selectively recognized as interference and filtered out. All the other pixels remain unaffected. If no (strongly remitting, bright) object is found, the recognition (and filtering) of the ghost pixels can be omitted and all the pixels remain untouched. This selective recognition (and filtering) of the ghost pixels can in particular be important for safety applications since it must be avoided here as far as possible that valid data portions (i.e. pixels of real, existing objects) are filtered out inadvertently.

A further subject of the invention is the use of an optoelectronic sensor described herein for detecting at least one object in a monitored zone.

A further subject of the invention is a method for detecting least one object in a monitored zone, wherein transmission light is transmitted into the monitored zone; wherein reception light remitted by the monitored zone, and in particular by the object in the monitored zone, is received; wherein distance data about the monitored zone, and in particular about the remitting object in the monitored zone, are obtained based on the reception light and are in particular measured by means of a time-of-flight method; wherein the distance data comprise intensity values and associated distance values; wherein a distance of the object is determined based on the distance data; and wherein those data portions in the distance data are recognized as interference in which an intensity value is smaller than a predetermined first intensity limit value and the associated distance value lies within a tolerance range around the determined distance of the object. The object is preferably a reflector. The advantages listed above can be achieved accordingly by the method in accordance with the invention.

According to one embodiment, a size and/or an intensity of the remitting object is/are further determined based on the distance data. The distance of the object is determined (only) if and/or the recognition of those data portions in the distance data which represent an interference is carried out (only) if the size of the object is equal to or greater than a predetermined size limit value and/or if the intensity of the object is equal to or greater than a predetermined second intensity limit value.

According to one embodiment, the distance data comprise a plurality of pixels that each have an intensity value and an associated distance value.

According to one embodiment, each pixel in the distance data whose intensity value is equal to or greater than the second intensity limit value is entered into a distance histogram, a peak is recognized in the distance histogram, wherein the peak is preferably the largest peak in the distance histogram, the size of the object is determined based on the number of pixels under the peak, and the distance of the object is determined based on the position of the peak in the distance histogram.

According to one embodiment, the first intensity limit value is determined in dependence on the distance of the object. Additionally or alternatively, according to one embodiment, the first intensity limit value is determined based on an intensity of an object to be detected or that can be detected (by the optoelectronic sensor) with the lowest remission, wherein the first intensity limit value is preferably limited (upwards) by a predetermined maximum value.

It is understood that what is described with respect to the optoelectronic sensor according to the invention also applies to the use of the optoelectronic sensor and to the method. This in particular applies to embodiments and advantages. Furthermore, it is to be understood that all the features and embodiments disclosed herein can be combined unless expressly stated otherwise.

The invention will be described in the following purely by way of example with reference to possible embodiments and to the enclosed drawing. There are shown:

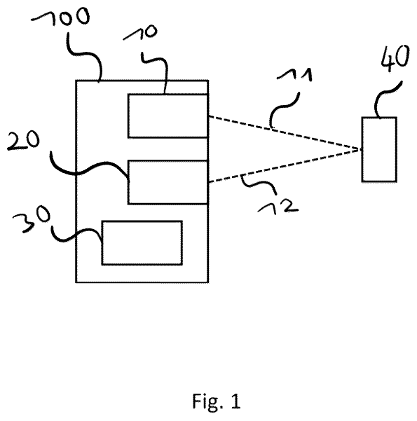

FIG. 1 a schematic representation of an optoelectronic sensor according to an embodiment of the invention;

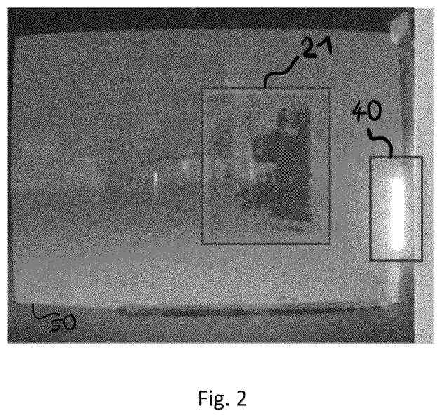

FIG. 2 a graphical representation of distance data obtained by means of an optoelectronic sensor according to one embodiment of the invention;

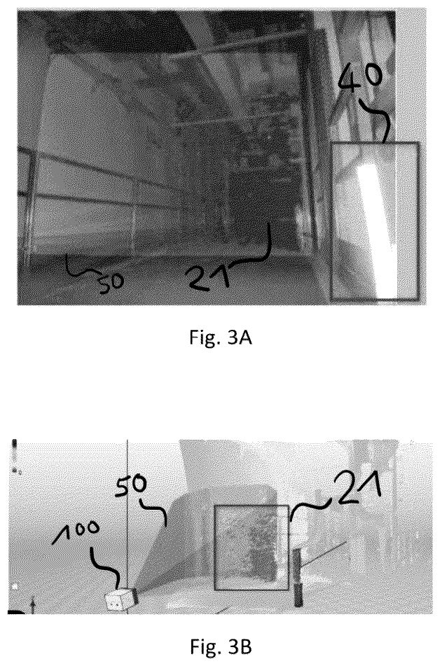

FIG. 3A a graphical representation of distance data obtained by means of an optoelectronic sensor according to one embodiment of the invention;

FIG. 3B a representation of distance data obtained by means of an optoelectronic sensor according to an embodiment of the invention in a software environment;

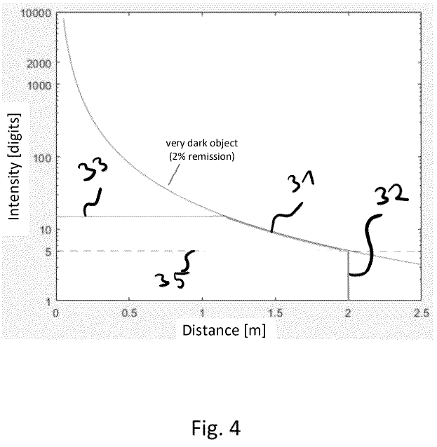

FIG. 4 a graphical representation of the recognition of data portions that represent an interference by means of an optoelectronic sensor according to an embodiment of the invention;

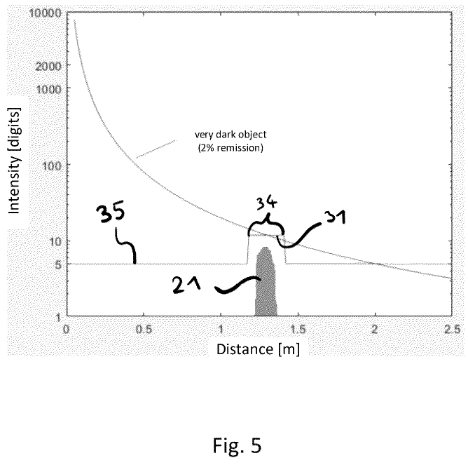

FIG. 5 a graphical representation of the recognition of data portions that represent an interference by means of an optoelectronic sensor according to an embodiment of the invention;

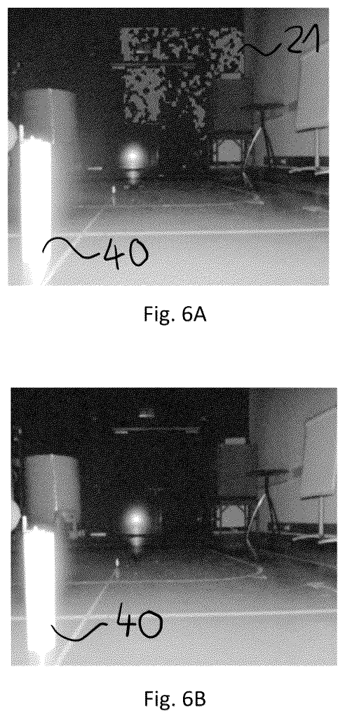

FIG. 6A a graphical representation of distance data obtained by means of an optoelectronic sensor according to an embodiment of the invention before the filtering of the data portions recognized as interference; and

FIG. 6B a graphical representation of distance data obtained by means of an optoelectronic sensor according to an embodiment of the invention after the filtering the data portions recognized as interference.

FIG. 1 shows an optoelectronic sensor 100, in particular a time-of-flight camera or a LIDAR sensor, according to one embodiment for detecting at least one object 40 in a monitored zone. The optoelectronic sensor 100 comprises a light transmitter 10, a light receiver 20 and an evaluation unit 30. The light transmitter 10 is configured to transmit transmission light 11 into the monitored zone. The light receiver 20 is configured to receive reception light 12 remitted by the monitored zone, and in particular by the object 40 in the monitored zone. The evaluation unit 30 is configured to obtain distance data (as shown, for example, in FIG. 2, FIG. 3A, FIG. 3B and FIG. 6A) about the monitored zone, and in particular about the remitting object 40 in the monitored zone, based on the reception light 12, wherein the distance data comprise intensity values and associated distance values. The evaluation unit 30 is further configured to determine a distance of the object 40 based on the distance data and to recognize those data portions in the distance data as interference in which an intensity value is smaller than a predetermined first intensity limit value and the associated distance value lies within a tolerance range around the determined distance of the object 40.

The evaluation unit 30 of the optoelectronic sensor shown in FIG. 1 can be configured, based on the distance data, to determine a size and/or an intensity of the remitting object 40 and to determine the distance of the object 40 (only) if and/or to carry out the recognition of those data portions in the distance data which represent an interference (only) if the size of the object 40 is equal to or greater than a predetermined size limit value and/or if the intensity of the object 40 is equal to or greater than a predetermined second intensity limit value. In this way, it can be avoided that valid data portions (i.e. data portions of real, existing objects) are inadvertently filtered out, which is particularly important for safety applications. If a plurality of sufficiently large and sufficiently remitting objects are recognized or detected, the process of the interference recognition can be iteratively carried out for each of the recognized objects.

As shown in FIG. 2, FIG. 3A, FIG. 3B, FIG. 6A and FIG. 6B, the distance data obtained can comprise a plurality of pixels that each have an intensity value and an associated distance value. It is understood that the evaluation unit 30 of an optoelectronic sensor 100, as shown, for example, in FIG. 1 or in FIG. 3B, can be configured to recognize those pixels 21 in the distance data as interference whose intensity value is smaller than a predetermined first intensity limit value and the associated distance value lies within a tolerance range around the determined distance of the object 40. The pixels 21 that represent an interference can arise due to multiple reflections and a scattering of the reception light at optical elements in the light receiver 20 of the optoelectronic sensor 100 and can be referred to as so-called ghost pixels 21.

Such ghost pixels 21 can trigger a warning or protected field 50 configured in the optoelectronic sensor 100 (as shown in FIG. 2, FIG. 3A and FIG. 3B) and can, as a result, unnecessarily cause a safety stop of an autonomous robot that can move in an industrial plant and in particular in the monitored zone in the industrial plant. It is understood that the optoelectronic sensor 100, as shown in FIG. 1 and FIG. 3B, can be attached to the autonomous robot and can in particular be moved along by it.

The evaluation unit 30 of an optoelectronic sensor, as shown in FIG. 1 or also in FIG. 3B, can be configured to enter each pixel in the distance data whose intensity value is equal to or greater than the second intensity limit value into a distance histogram, to recognize a peak in the distance histogram, wherein the peak is preferably the largest peak in the distance histogram, to determine the size of the object 40 based on the number of pixels under the peak and to determine the distance of the object 40 based on the position of the peak in the distance histogram.

FIG. 2 graphically represents distance data that are obtained about a monitored zone and that were obtained by means of an evaluation unit 30 of an optoelectronic sensor 100 shown in FIG. 1. In FIG. 2, the distance data obtained about the object 40 and the data portions 21 in the distance data that represent an interference, i.e. the ghost pixels 21, are each marked with a rectangular frame. The object 40 can be a reflector and in particular a retroreflector.

Similar to FIG. 2, FIG. 3A graphically represents distance data that are obtained about a monitored zone and that were obtained by means of an evaluation unit 30 of an optoelectronic sensor 100 shown in FIG. 1. In FIG. 3A, the distance data obtained about the object 40 are marked with a rectangular frame.

FIG. 3B shows a representation of the distance data from FIG. 3A in a software environment that can be presented to a user of the optoelectronic sensor 100 by means of a GUI (Graphical User Interface) on a display device. The ghost pixels 21 are marked with a rectangular frame and can trigger a warning or protected field 50 of the optoelectronic sensor 100. The optoelectronic sensor 100 shown in FIG. 3B has the same or similar elements as the optoelectronic sensor in FIG. 1. Accordingly, the optoelectronic sensor in FIG. 3B fulfills the same or similar functions as described herein for the optoelectronic sensor in FIG. 1.

FIG. 4 is a graphical representation of the recognition of ghost pixels by means of an optoelectronic sensor 100, as shown, for example, in FIG. 1 or in FIG. 3B. In other words, FIG. 4 shows a graphical representation of the creation of a filter for the distance data, with which filter ghost pixels can be recognized and filtered out. The recognized ghost pixels can, in particular for the control of the movement of a robot, be removed or filtered out of the distance data, marked as invalid and/or ignored during a further evaluation of the distance data. In this way, it can be avoided that the ghost pixels trigger a protected or warning field 50 of the optoelectronic sensor 100, as shown in FIG. 3B.

As shown in FIG. 4, the filter can be created based on the first intensity limit value 31, a distance limit value 32, a maximum value 33 and a third intensity limit value 35. The distance limit value 32 has the effect that only the pixels whose distance is equal to or less than the distance limit value 32 are considered for the interference recognition. In other words, if the object 40 is not at a distance from the optoelectronic sensor 100 that is equal to or less than the distance limit value 32, the interference recognition is not carried out. As shown in FIG. 4, the distance limit value 32 can be 2 m. For safety reasons, the filter can be limited upwards by a predetermined maximum value 33. As shown in FIG. 4, the maximum value 33 can be 15 digits. The first intensity limit value 31 can be determined as a function of a minimum intensity limit value at the distance limit value 32, of the distance limit value 32, and of the distance of the object (not shown in FIG. 4). In FIG. 4, the first intensity limit value 31 was determined using the following equation 1,

$${I}_{t h r , 1} = {I}_{min} \cdot {( \frac{{D}_{t h r}}{{D}_{o b j}} )}^{2} , \qquad [ Equation 1 ]$$

wherein the first intensity limit value 31 in equation 1 is represented by the parameter I_{thr,1}, the distance limit value 32 in equation 1 is represented by the parameter Dₜₕᵣ, Iₘᵢₙ is the minimum intensity limit value at the distance limit value Dₜₕᵣ, and D_{obj} is the distance of the object shown in FIGS. 6A and 6B (here approximately 90 cm). The minimum intensity limit value Iₘᵢₙ at the distance limit value 32 can correspond to a remission of 2%, which corresponds to a percentage of 50% of the intensity of an object still to be detected or that can be detected, which object can be defined in the detection concept of the optoelectronic sensor 100 with a remission of 4%. For the representation in FIG. 4, the minimum intensity limit value Iₘᵢₙ has the value of 5 digits. The third intensity limit value 35 in the filter in FIG. 4 has the effect that all the pixels in the distance data (here independent of their associated distance value) are recognized as interference in which the intensity value is smaller than the third intensity limit value 35. As shown in FIG. 4, the third intensity limit value 35 can be independent of the distance and can preferably be set to a standard value, in this case 5 digits.

FIG. 5 is a graphical representation of the recognition of ghost pixels by means of an optoelectronic sensor, as shown, for example, in FIG. 1 or FIG. 3B. In other words, FIG. 5 shows a graphical representation of the creation of a filter for the distance data, wherein the filter in FIG. 5 has similar or the same properties as the filter in FIG. 4. As shown in FIG. 5, the filter can be created based on the first intensity limit value 31, a maximum value 33, a third intensity limit value 35 and the tolerance range 34. The first intensity limit value 31 in FIG. 5 is determined in the same way as the first intensity limit value 31 in FIG. 4, using equation 1. As can be seen in FIG. 5, the determined first intensity limit value 31 can have a value of 11.8 digits and is thus below a maximum value 33 (not shown in FIG. 5) of 15 digits, as shown in FIG. 4. The third intensity limit value 35 of the filter in FIG. 5 has the effect that all the pixels in the distance data 40 are recognized as interference for which the intensity value is smaller than the third intensity limit value 35 and the associated distance value is outside the tolerance range 34 around the determined distance of the object. As with the filter in FIG. 4, the third intensity limit value 35 can have a value of 5 digits. In other words, for the interference recognition, as shown here for the filter in FIG. 5, all the pixels with distance values within the tolerance range 34 can be checked for the first intensity limit value 31 and all the pixels with distance values outside the tolerance range 34 can be checked for the third intensity limit value 35. The tolerance range 34 is determined, as described herein, based on the determined distance of the object 40, wherein a distance of the object of 130 cm was assumed here in FIG. 5. In FIG. 5, the tolerance range 34 corresponds to a range of ±12 cm around the determined distance of the object 40 shown in FIGS. 6A and 6B, i.e., in other words, a distance corridor of 118 cm to 142 cm (viewed relative to the optoelectronic sensor). As can be seen in FIG. 5, the determined distance of the object 40 is below a distance limit value 32 of 2 m (cf. FIG. 4). All the ghost pixels 21 that lie below this filter shown in FIG. 5 can then be recognized and filtered out of the distance data.

FIG. 6A shows a graphical representation of distance data obtained by means of an optoelectronic sensor, as shown, for example, in FIG. 1 or FIG. 3B, before the filtering of the ghost pixels 21 using the filter shown in FIG. 5. FIG. 6B shows a graphical representation of the distance data from FIG. 6A after the filtering of the ghost pixels 21 (not shown in FIG. 6B) using the filter shown in FIG. 5.

Reference numeral list

| | |
|---|---|
| 100 | optoelectronic sensor |
| 10 | light transmitter |
| 11 | transmission light |
| 12 | reception light |
| 20 | light receiver |
| 21 | pixels recognized as interference |
| 30 | evaluation unit |
| 31 | first intensity limit value |
| 32 | distance limit value |
| 33 | maximum value |
| 34 | tolerance range |
| 35 | third intensity limit value |
| 40 | object |
| 50 | protected field |
| SICK AG | S30202PUS - Br/Sl |

1. An optoelectronic sensor for detecting at least one object in a monitored zone,
wherein the optoelectronic sensor comprises a light transmitter, a light receiver and an evaluation unit,
wherein the light transmitter is configured to transmit transmission light into the monitored zone,
wherein the light receiver is configured to receive reception light remitted by the monitored zone, and
wherein the evaluation unit is configured
to obtain distance data about the monitored zone based on the reception light,
wherein the distance data comprise intensity values and associated distance values,
to determine a distance of the object based on the distance data, and to recognize those data portions in the distance data as interference in which an intensity value is smaller than a predetermined first intensity limit value and the associated distance value lies within a tolerance range around the determined distance of the object.

2. The optoelectronic sensor according to claim 1, wherein the optoelectronic sensor is one of a time-of-flight camera and a LiDAR sensor.

3. The optoelectronic sensor according to claim 1,
wherein the light receiver is configured to receive reception light remitted by by the object in the monitored zone.

4. The optoelectronic sensor according to claim 1, wherein the evaluation unit is configured to obtain distance data about the remitting object in the monitored zone based on the reception light.

5. The optoelectronic sensor according to claim 1, wherein the object is a reflector.

6. The optoelectronic sensor according to claim 1, wherein the evaluation device is configured
to determine a size and/or an intensity of the remitting object based on the distance data, and
to determine the distance of the object and/or to carry out the recognition of those data portions in the distance data which represent an interference if the size of the object is equal to or greater than a predetermined size limit value and/or if the intensity of the object is equal to or greater than a predetermined second intensity limit value.

7. The optoelectronic sensor according to claim 6,
wherein the distance data comprise a plurality of pixels that each have an intensity value and an associated distance value, and
wherein the evaluation unit is configured
to enter each pixel in the distance data whose intensity value is equal to or greater than the second intensity limit value into a distance histogram,
to recognize a peak in the distance histogram, wherein the peak is preferably the largest peak in the distance histogram,
to determine the size of the object based on the number of pixels under the peak, and
to determine the distance of the object based on the position of the peak in the distance histogram.

8. The optoelectronic sensor according to claim 1, wherein the evaluation unit is configured to compare the distance of the object with a predetermined distance limit value, and to carry out the recognition of those data portions which represent an interference only if the distance is equal to or smaller than the distance limit value.

9. The optoelectronic sensor according to claim 1,
wherein the first intensity limit value is determined in dependence on the distance of the object.

10. The optoelectronic sensor according to claim 1,
wherein the first intensity limit value is defined based on an intensity of an object to be detected or that can be detected with the lowest remission.

11. The optoelectronic sensor according to claim 10,
wherein the first intensity limit value is limited by a predetermined maximum value.

12. The optoelectronic sensor according to claim 1, wherein the first intensity limit value is determined as a function
of a minimum intensity limit value at a predetermined distance limit value,
of the distance limit value, and
of the distance of the object.

13. The optoelectronic sensor according to claim 12,
wherein the minimum intensity limit value at the predetermined distance limit value corresponds to a remission of 2%.

14. The optoelectronic sensor according to claim 1, wherein the evaluation unit is configured to recognize those data portions in the distance data as interference in which the intensity value is smaller than a predetermined third intensity limit value.

15. The optoelectronic sensor according to claim 14, wherein the evaluation unit is further configured to recognize those data portions in the distance data as interference in which the intensity value is smaller than the predetermined third intensity limit value and the associated distance value is outside the tolerance range around the determined distance of the object.

16. The optoelectronic sensor according to claim 15, wherein the third intensity limit value is set to a fixed value.

17. The optoelectronic sensor according to claim 1, wherein the data portions in the distance data that are recognized as interference are removed from the distance data, marked as invalid and/or ignored in a further evaluation of the distance data.

18. Method of using an optoelectronic sensor according to claim 1 for detecting at least one object in a monitored zone.

19. A method for detecting least one object in a monitored zone,
wherein transmission light is transmitted into the monitored zone;
wherein reception light remitted by the monitored zone is received;
wherein distance data about the monitored zone are obtained based on the reception light, wherein the distance data comprise intensity values and associated distance values;
wherein a distance of the object is determined based on the distance data; and
wherein those data portions in the distance data are recognized as interference in which an intensity value is smaller than a predetermined first intensity limit value and the associated distance value lies within a tolerance range around the determined distance of the object.

20. The method according to claim 19,
wherein a size and/or an intensity of the remitting object is/are further determined based on the distance data, and
the distance of the object is determined if the size of the object is equal to or greater than a predetermined size limit value and/or if the intensity of the object is equal to or greater than a predetermined second intensity limit value.

21. The method according to claim 19,
wherein the first intensity limit value is determined in dependence on the distance of the object, and/or
wherein the first intensity limit value is determined based on an intensity of an object to be detected or that can be detected with the lowest remission.
